(19) United States
(12) Patent Application Publication
(10) Pub. No.: US 2013/0196117 A1
(43) Pub. Date: Aug. 1, 2013

(54) INSULATED AND CALIBRATED BRICK AND PRODUCTION METHOD THEREOF

(71) Applicant: Lüleci Hüseyin, Istanbul (TR)

(72) Inventor: Lüleci Hüseyin, Istanbul (TR)

(21) Appl. No.: 13/813,350

(22) PCT Filed: Mar. 8, 2011
(86) PCT No.: PCT/TR11/00058

§ 371 Date: Apr. 8, 2013

(30) Foreign Application Priority Data
Jul. 30, 2010 (TR) 2010/06328

(51) Int. Cl. B28B 19/00; E04C 1/41

(52) U.S. Cl. CPC B28B 19/003; E04C 1/41
USPC 428/157; 264/157; 428/454; 428/319.1; 428/452; 428/161

(57) ABSTRACT

An insulated brick (12) and the production method (100) thereof. The production method (100) of the insulated brick, which is the subject of this invention, includes a mold (1), at least one insulation panel (2) placed in the mold (1) and mortar (3) as well as at least one disc (5) that enables the wiping and dimensioning of the surface by means of cutting tool (4) which breaks down the block (6) that has been produced in the mold (1).

### TECHNICAL FIELD

This invention relates to a heat- and sound-proof light brick and the production method thereof.

### PREVIOUS TECHNIQUE

In the state of art, the bricks that are used in the construction of buildings are produced either by placing insulation material between dry concrete style bricks that are poured into forms or pouring dry concrete around the insulation material one by one. In the French patent document numbered FR2609079 A1, such a production method is cited.

Another production method in the state of art is the formation of brick or wall by pouring concrete between insulation panels. In the French patent document numbered FR2575778 A, such a production method is mentioned.

Another technique is to form raw blocks by pouring light concrete within a mold and to ensure that brick is formed by cutting this block. In the English patent document numbered GB790881, cutting of the light mortar that is poured into the mold is cited.

In the Turkish patent document numbered TR200607298, a method, in which insulated brick, that is placed into a mold, being cut, is cited. In this application of the known status of the technique, production moves very slowly and this causes an increase in production costs.

### A SHORT DESCRIPTION OF THE INVENTION

The object of this invention is to apply an insulated brick production method in which fast cutting process is possible by means of serial production.

Another object of this invention is to perform insulated brick production method in which production costs are reduced.

### DETAILED DESCRIPTION OF THE INVENTION

To achieve the object of this invention, the steps of producing insulated and calibrated light brick and the method of production of such brick are demonstrated in the attached figures and these figures pertain to following aspects of the invention;

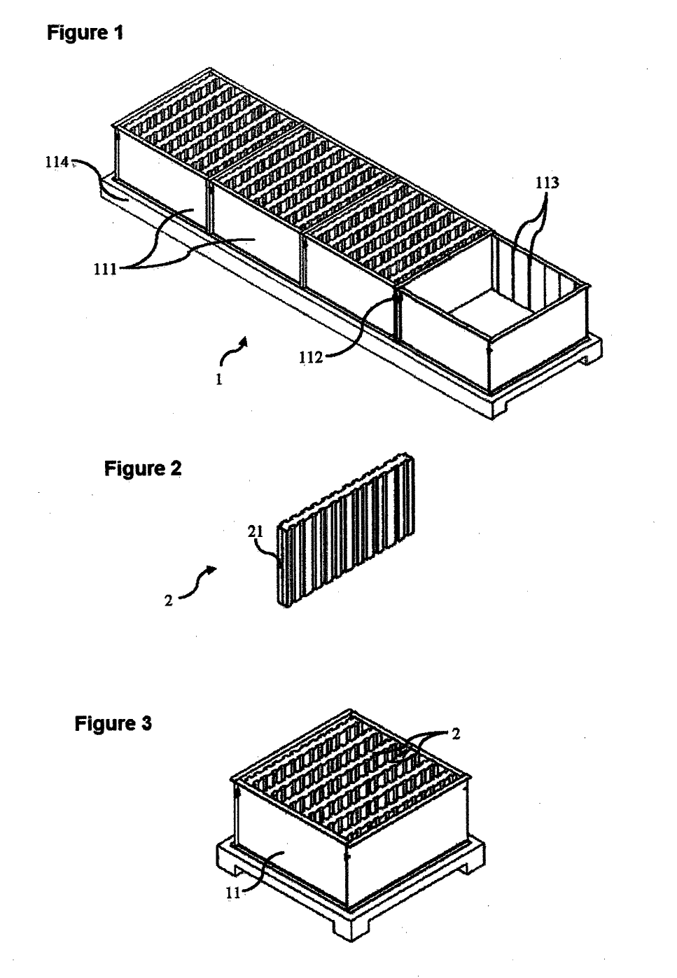

FIG. 1. Perspective view of the raw block mold.

FIG. 2. Perspective view of insulation panel.

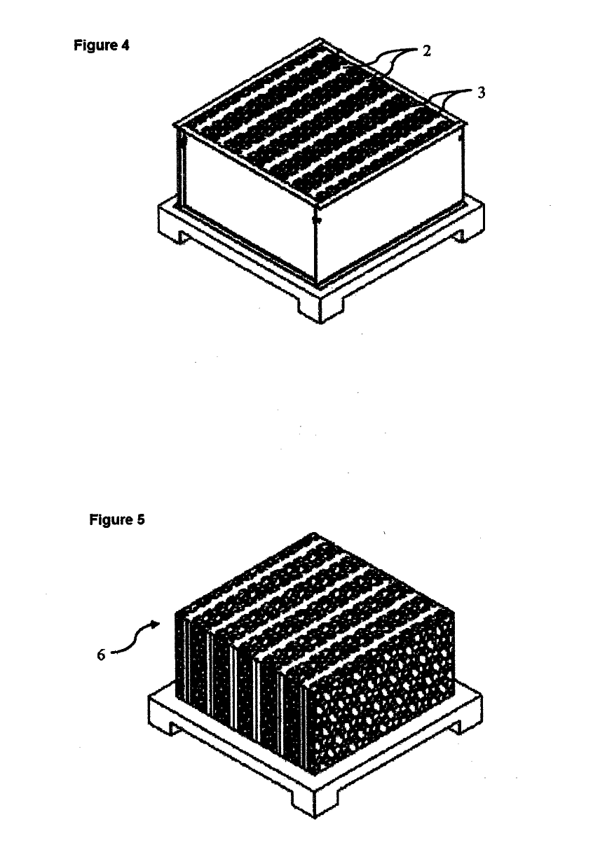

FIG. 3. Perspective view illustrating the placement of insulation panels in the mold.

FIG. 4. Perspective view illustrating the pouring of mortar between the insulation panels placed in the mold.

FIG. 5. Perspective view of the raw block featuring the insulation panel out of the mold.

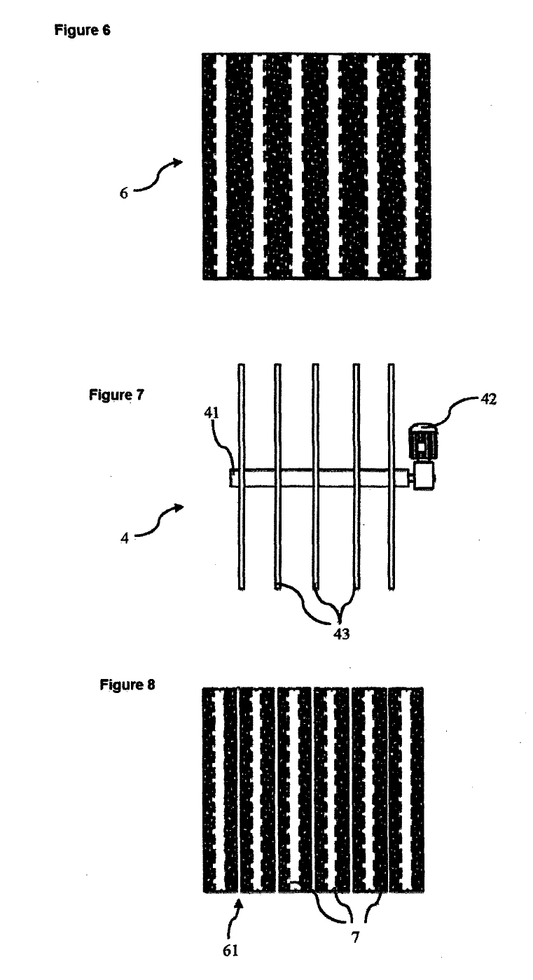

FIG. 6. Top view of the raw block with the insulation panel.

FIG. 7. Schematic view of the multi cutter.

FIG. 8. Top view of the sliced status of raw block.

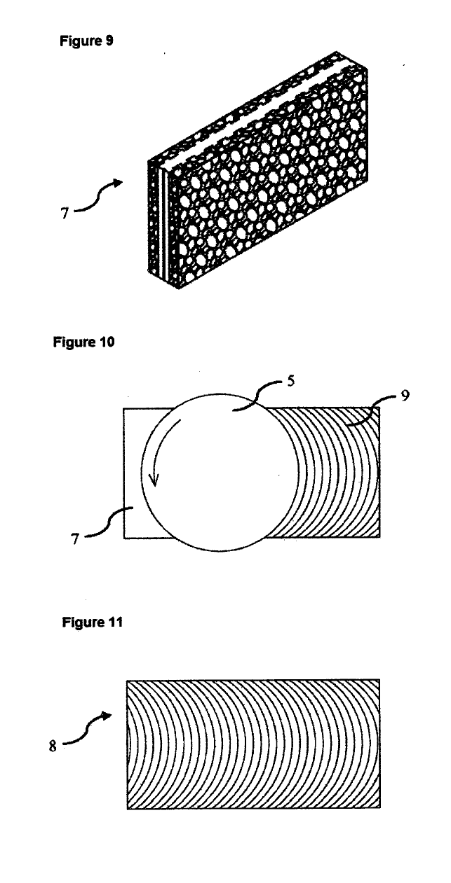

FIG. 9. Perspective view of a slice with insulation panel that has been sliced out of raw block.

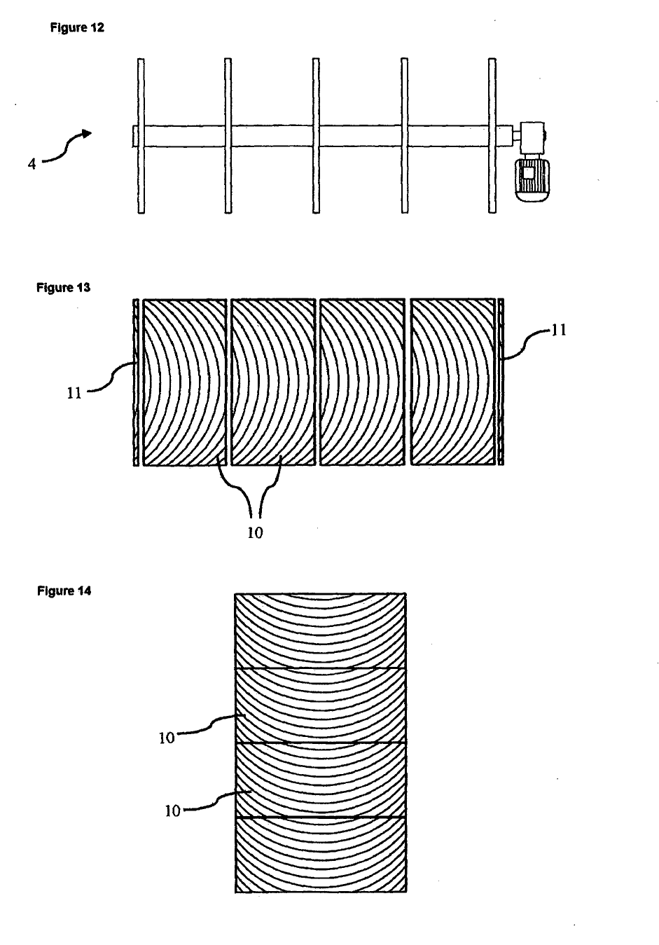

FIG. 10. Top view illustrating the wiping of the slice with insulation panel by means of calibration disc.

FIG. 11. Top view of the wiped slice with insulation panel with wiping traces.

FIG. 12. Schematic view showing the utilization of multi cutter in dimensioning of the slice with insulation panel by transverse cutting.

FIG. 13. Top view of the slice that has been cut transversely.

FIG. 14. Top view of the insulated slice that has been multi-cut transversely and separated from losses.

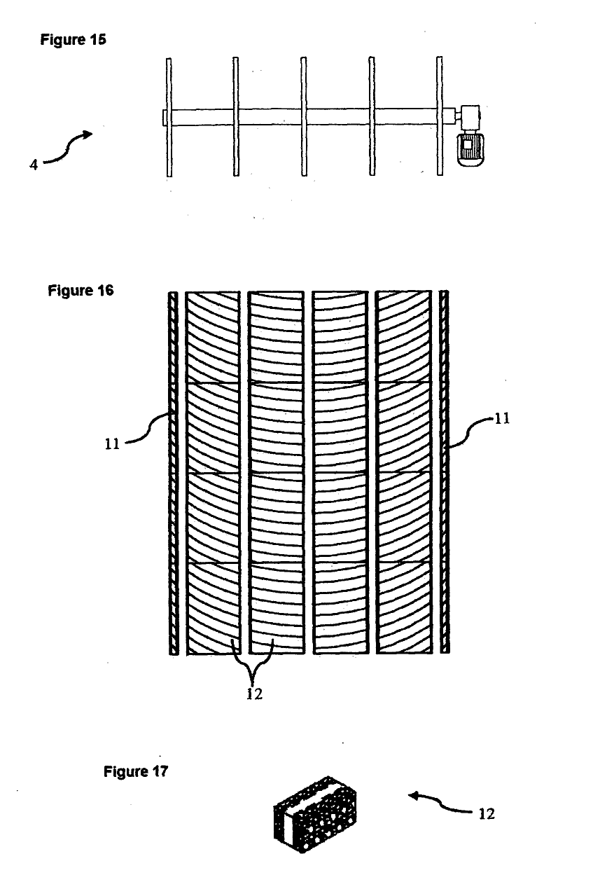

FIG. 15. Schematic view showing the utilization of multi cutter in dimensioning by cutting lengthwise.

FIG. 16. Top view of the insulated slice multi-cut lengthwise.

FIG. 17. Perspective view of the insulated and calibrated brick.

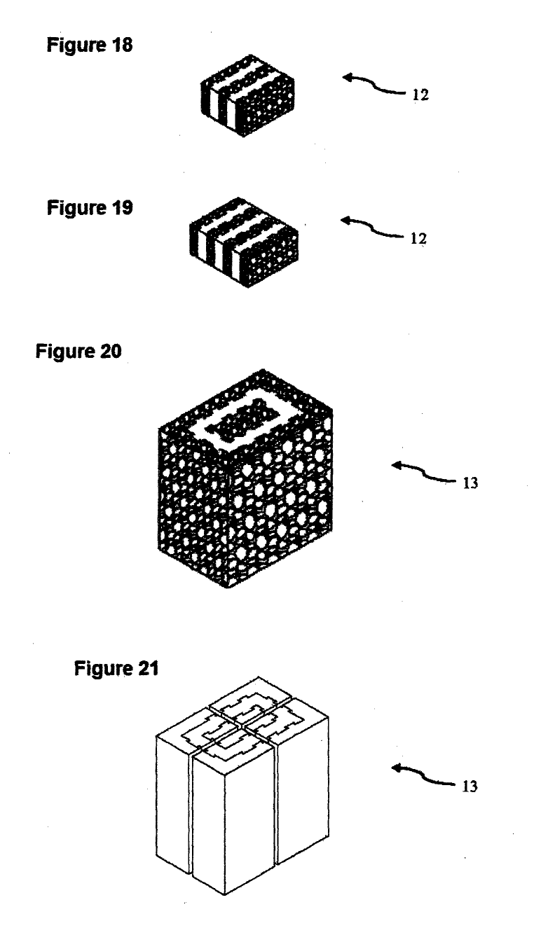

FIG. 18. Perspective view of the double insulated brick.

FIG. 19. Perspective view of the multi-insulated brick.

FIG. 20. Perspective view of the insulated raw block, which has been poured into form in order to produce angle brick, after having been taken out of the mold.

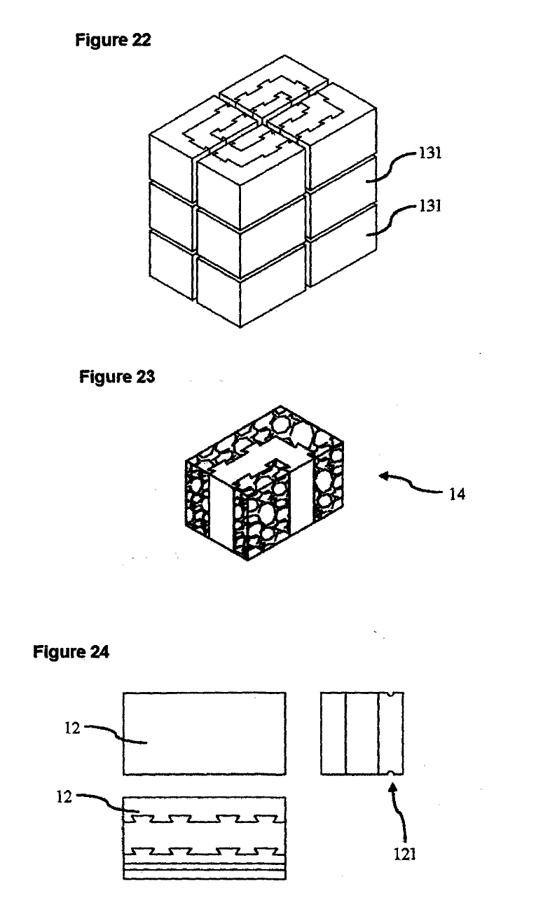

FIG. 21. Perspective view illustrating the vertical sliced status of the raw block to be used as a corner brick.

FIG. 22. Perspective view illustrating the horizontal sliced status of raw block to be used as a corner brick.

FIG. 23. Perspective view of the insulated and calibrated corner brick that is formed after cuffing processes.

FIG. 24. The view illustrating the appearance of insulated brick having assembly channels from three angles.

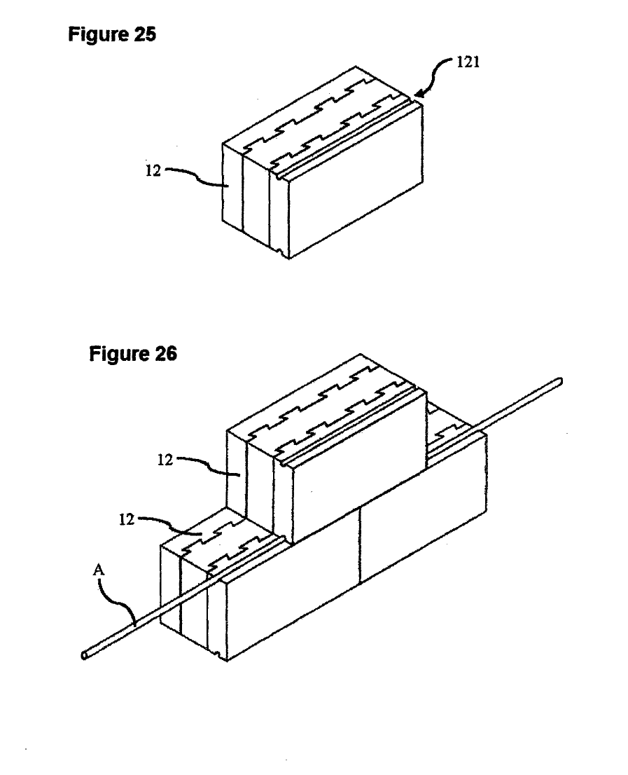

FIG. 25. Perspective view of the insulated brick with assembly channels.

FIG. 26. Perspective view of the insulated brick with assembly channel including the assembly wick.

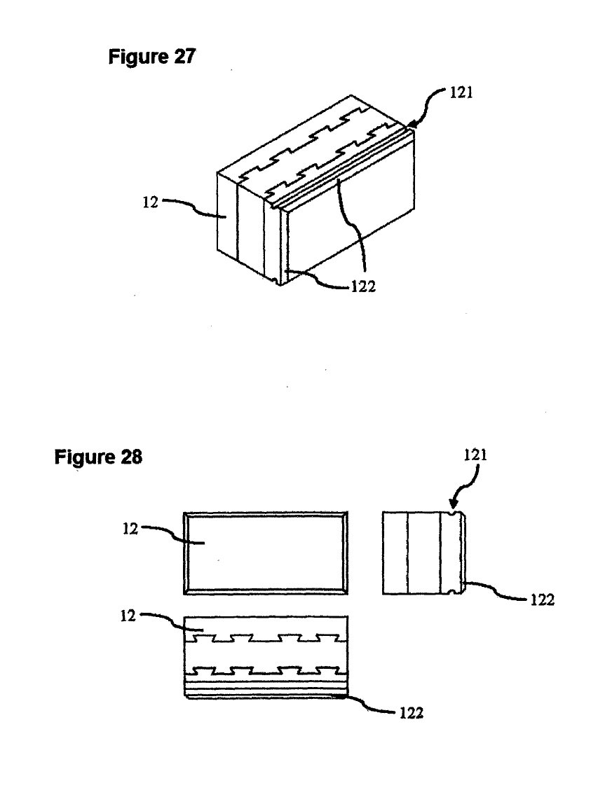

FIG. 27. Perspective view of the assembly channeled and joint chamfered insulated brick.

FIG. 28. View illustrating the appearance of assembly channeled and joint chamfered insulated brick from three angles.

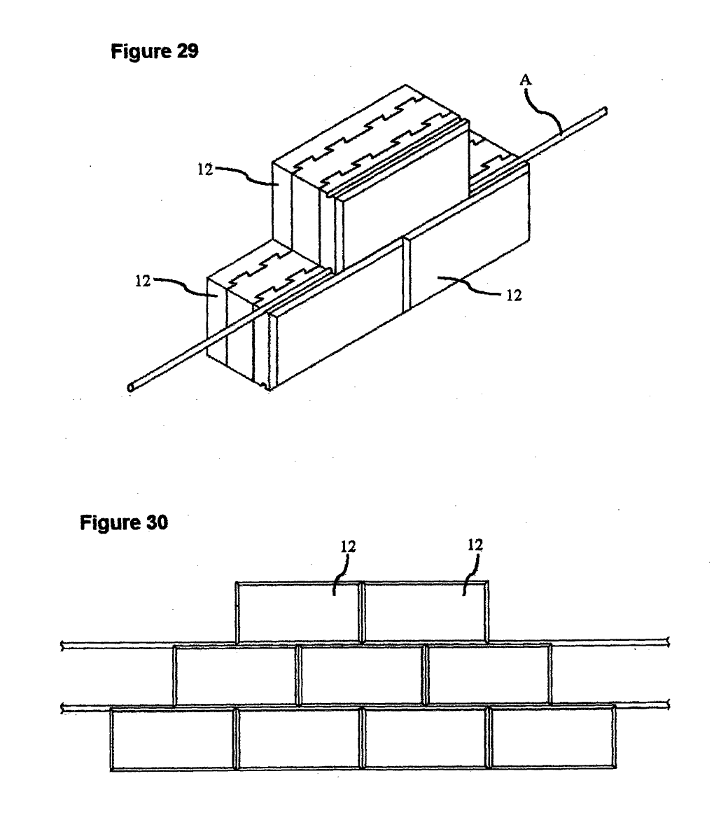

FIG. 29. Perspective view of the assembly channeled and joint chamfered insulated brick including the assembly fuse.

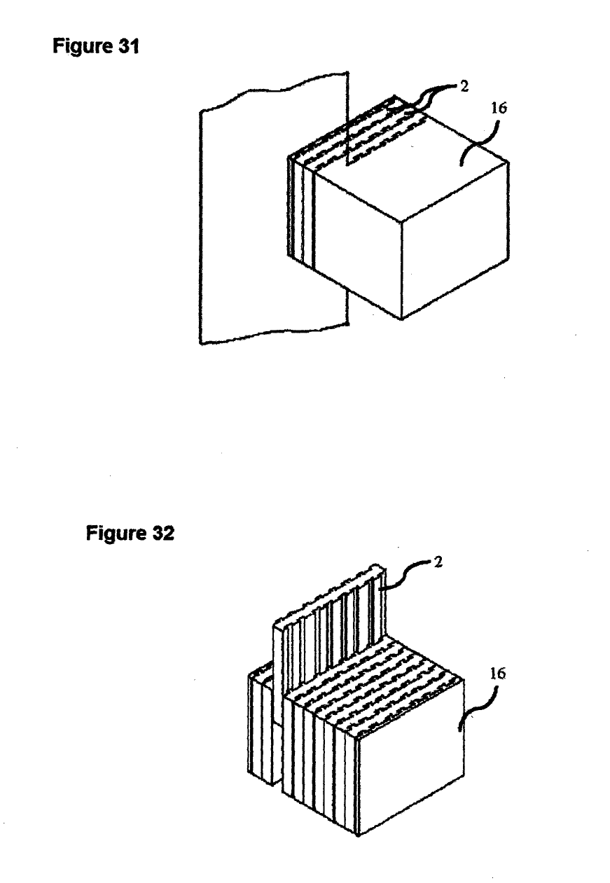

FIG. 30. Front view of the assembly channeled and joint chamfered insulated brick including assembly fuse.

FIG. 31. Perspective view of the block in which insulation panel is produced.

FIG. 32. View showing the extraction of insulation panels from insulation block.

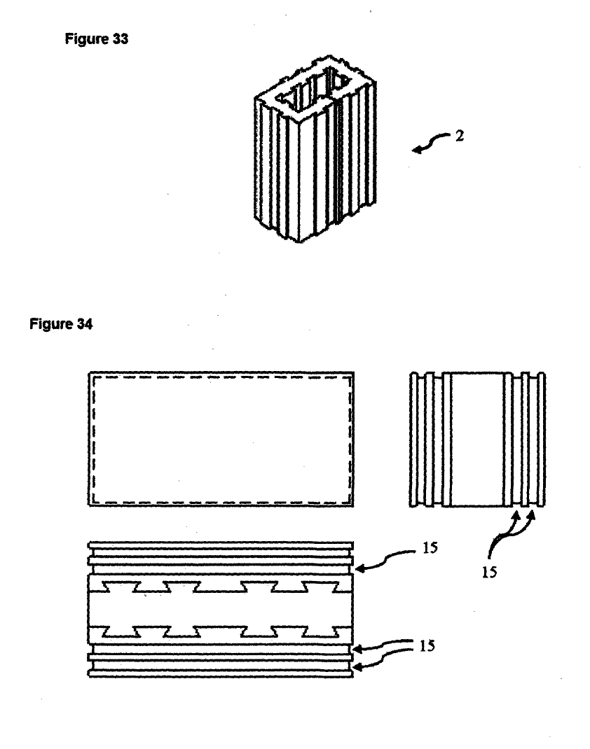

FIG. 33. Perspective view of the insulation panel used in the corner application.

FIG. 34. View illustrating the appearance of adhesion channeled brick from three angles.

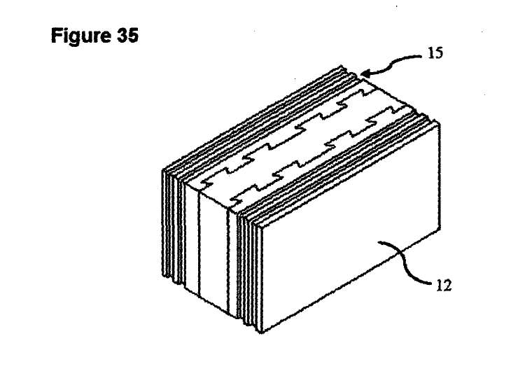

FIG. 35. Perspective view of the adhesion channeled brick.

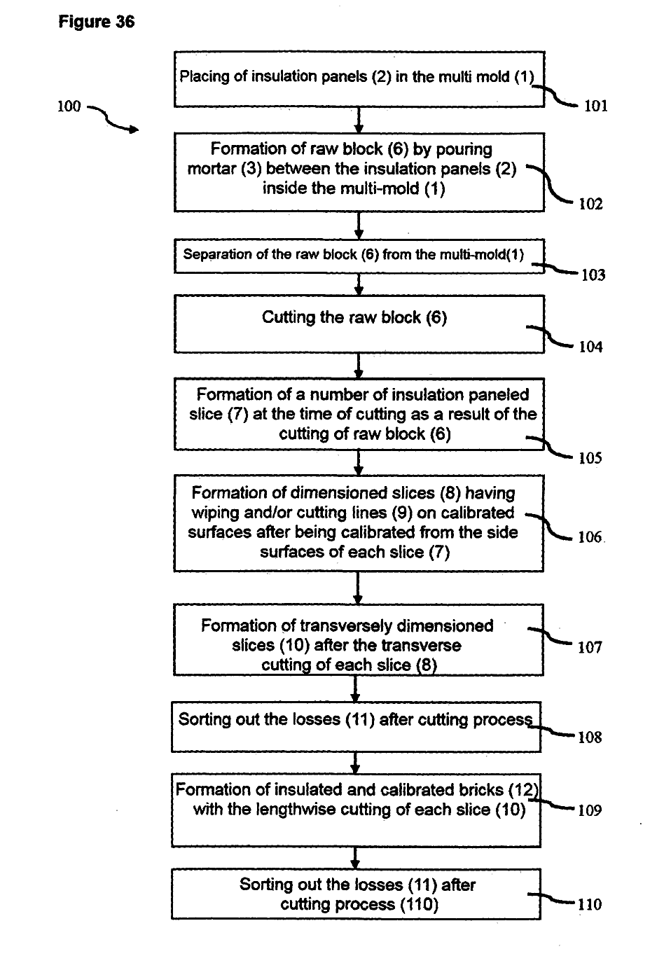

FIG. 36. Flow diagram illustrating the production method of the insulated brick.

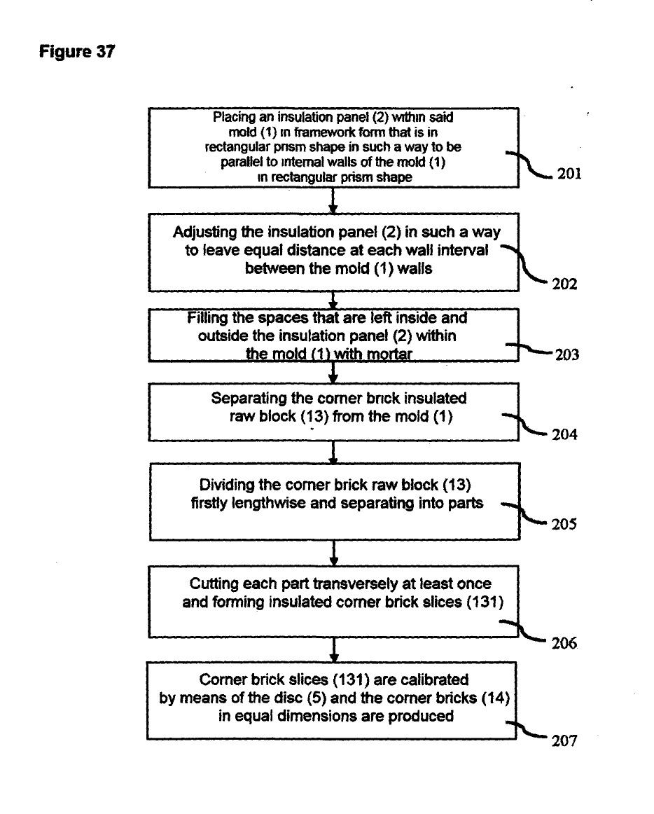

FIG. 37. Flow diagram illustrating the cornerstone application of insulated brick production method.

The parts in the figures have been assigned by numbers and their correspondences are given below.

100. Method

1. Multi-mold
111. Internal mold
112. Opening mechanism
113. Protrusion
114. Base

2. Insulation panel
21. Channel

3. Mortar

4. Cutting tool
41. Shaft
42. Engine
43. Cutter

5. Disc

6. Raw block
61. Cutting space (kerf)

7. Slice with insulation panel

8. Wiped and dimensioned slice

9. Wiping and/or cutting traces

10. Transversely dimensioned slice

11. Loss

12. Insulated and calibrated brick
121. Assembly channel
122. Corner joint chamfer

13. Corner brick insulated raw block

131. Corner brick slices

14. Corner brick

15. Adhesion channel

16. Insulation block
A. Assembly wick

The production method (100) of the insulated brick, which is the subject of this invention, includes at least a mold (1), at least one insulation panel (2) placed in the mold (1) and mortar (3) as well as at least one cutting tool (4) and at least one disc (5) that enables the wiping and dimensioning of the surface.

The multi-mold (1) includes at least one internal mold (111), at least one opening mechanism (112), at least one protrusion (113) that is formed in order to place the panel/panels (2) inside the internal form (111) and at least one base (114) holding the bottom of the mold (1) (FIG. 1).

Insulation panel (2) includes at least one channel (21) that is formed in order to place the panel (2) inside the mold (1) (FIG. 2). Insulation panel (2) is made of compressed chip, wood, chaff, fodder, nutshell, corncob, etc. or EPS (Expanded Polystyrene) foam. In the preferred implementation of the invention, the insulation panel (2) that is made of EPS foam is produced by cutting from a big insulation block (16) by means of a heated wire preferably (FIG. 34). Heated wire moves forward in spiral movements within the insulation block (16) and thus a great number of insulation panel (2) can be produced without a loss from the insulation block (16) thanks to this production.

Cutting tool (4) includes at least one shaft (41), at least one engine (42) and a number of cutter (43) (FIG. 7). In various applications of the invention, different cutting methods such as water jet, wire cutter, laser, etc. can be used instead of the cutting tool (4).

A raw block (6) that contains the insulation panel (2) and mortar (3) is produced within the mold (1).

With the cutting of the raw block (6), a number of slice with insulation panel (7) is formed including at least one slice of insulation panel (2) and at least two slices of concrete mortar (3).

The insulated brick production method (100), which is the subject of the invention, includes the following steps in its basic application:
Placing the insulation panels (2) inside the multi-mold (1) (101),
Formation of raw block (6) by pouring mortar (3) between the insulation panels (2) inside the multi-mold (1) (102),
Separation of the raw block (6) from the multi-mold(1) (103),
Cutting the raw block (6) (104),
Formation of a number of insulation paneled slice (7) at the time of cutting as a result of the cutting of raw block (6) (105),
Formation of dimensioned slices (8) having wiping and/or cutting lines (9) on calibrated surfaces after being calibrated from the side surfaces of each slice (7) (106),
Formation of transversely dimensioned slices (10) after the transverse cutting of each slice (8) (107),
Sorting out the losses (11) after cutting process (108),
Formation of insulated and calibrated bricks (12) with the lengthwise cutting of each slice (10) (109),
Sorting out the losses (11) after cutting process (110),

Raw block (6), insulated and paneled slices (7) that are formed as a result of the cutting of raw block (6) and transversely dimensioned slices (10) are cut by using more than one cutting tool (4) including more than one cutter (43). In another application of the invention, raw block (6), insulated paneled slices (7) and transversely dimensioned slices (10) are divided by more than one cut by means of a cutting tool (4) including a single cutter (43).

While insulation panels (2) are placed inside the multi-mold (1), the protrusion (13) enters inside the channel (21). After insulation panels (2) have been placed, mortar (3) is poured between the insulation panels (2) within the multi-mold (1). Then, multi-mold (1) is separated from the material inside (FIG. 5). Then, raw block (6) is cut by means of the cutting tool (4) including more than one cutter (43) (FIGS. 6, 8). More than one insulation paneled slice (7) is formed as a result of the cutting of the multi-mold (1) with the cutting tool (4) including more than one cutter (43). Thus, a lot of parts can be produced by using a single mold (1). Consequently, production duration of each part and the cost are reduced. Each insulation paneled slice (7) includes at least one insulation panel (2) (FIG. 9).

During the multi cutting of the raw block (6), slices (7) in same dimensions are formed. However, there might be millimetric differences between the sizes of slices (7). Each slice (7) is calibrated from the side surfaces by means of the disc (5). Thus, these millimetric differences that are formed during cutting are eliminated (FIG. 10). There are wiping traces on the calibrated surfaces of each slice (8) that are calibrated (FIG. 11). Then, each slice (8) is cut again by means of the cutting tool (4) transversely (FIGS. 12,13). The transverse slice (10), which is formed after the cutting, is purified from the losses (11) remaining on the side surfaces and cut again by means of the cutting tool (4) lengthwise (FIGS. 14, 15). The losses (11) remaining on side surfaces are sorted out again (FIG. 16). Thus, insulated and calibrated brick (12) is formed.

In an application of the invention, assembly channels (121) that stretch on horizontal direction on two parallel surfaces are opened on the adhesion surfaces of the insulated and calibrated brick (1) to be formed during construction (FIG. 24). In this application, an assembly wick (A) is passed through the channels (121) that are in line during the formation of wall by bringing the bricks (1) together and consequently bricks can be assembled in line (FIG. 26).

In another application of the invention, joint chamfer (122) is, opened on the edges of a surface that is parallel to the insulation part (2) of the bricks (1) (FIG. 27). During the formation of wall by bringing the bricks (1) having feature of joint chamfer (122) together, the joint material that connects bricks (1) may leak between the bricks (1) and thus the wall gains an aesthetic appearance by creating the impression that there is a certain distance between the bricks (1) (FIGS. 29, 30).

In an application of the invention, mold (1) is separated from the material within by means of the mold opening mechanism (11) (FIG. 1).

In an application of the invention, each brick (12) is produced solely within the mold (1), wiped and calibrated and thus made ready to be used.

In another application of the invention, at least one adhesion channel (15) is opened on contact surfaces of each brick (12) and thus bricks (12) adhere to each other more solidly.

In an application of the invention, using the insulated brick production method (100), the corner bricks are produced (14) that ensure uninterrupted insulation at wall corners where insulated bricks (12) are used (FIG. 23). This method includes following steps;

Placing an insulation panel (2) within said mold (1) in framework form that is in rectangular prism shape in such a way to be parallel to internal walls of the mold (1) in rectangular prism shape (201),
Adjusting the insulation panel (2) in such a way to leave equal distance at each wall interval between the mold (1) walls (202),
   Filling the spaces that are left inside and outside the insulation panel (2) within the mold (1) with mortar (203),
   Separating the corner brick insulated raw block (13) from the mold (1) (204),
   Dividing the corner brick raw block (13) firstly lengthwise and separating into parts (205),
   Cutting each part transversely at least once and forming insulated corner brick slices (131) (206). Corner brick slices (131) are calibrated by means of the disc (5) and the corner bricks (14) in equal dimensions are produced (207).

Corner brick raw block (13) and the parts that are formed as a result of the cutting of said corner brick raw block (13) are divided by using a cutting tool (4) that includes more than one cutter preferably (43).

In the application of formation of corner stone, a rectangular prism shaped mold (1) is used in the method (100). An insulation panel (2) that is in a framework shape with a quadrangle form is placed in the middle of the mold (1) in such a way to be parallel with internal walls of the mold (1). Insulation panel (2) is placed in such a way to leave equal distance between each wall among the mold (1) walls. Then, the spaces inside and outside the insulation panel (2) within the mold (1) are filled with mortar (3). Thus, angle brick insulated raw block (13) is formed (FIG. 20). Then, angle brick insulated raw block (13) is cut by means of the cutting tool (4). Angle brick raw block (13) is firstly divided in four lengthwise and thus slices that include an insulation panel (2) with a cross section in “L” shape are formed (FIG. 21). Each part is cat transversely at least once and insulated corner brick slices (131) are produced (FIG. 22). Corner brick slices (131) form continuous structure by continuing uninterruptedly at 90° at corners. Thus, no thermal bridge is formed at corners and uninterrupted insulation is ensured. The angle brick slices (131) are calibrated, by means of the disc (5) and the millimetric size differences that are formed during cutting are eliminated. Consequently, corner bricks (14) at equal sizes are produced (FIG. 23). In the corner brick application of the invention, the cutting wire circles around the insulation block (16) both inside and outside and an insulation panel (2) that is in framework shape with a quadrangle form is produced.

In this particular invention, production cost is reduced and the number of bricks that are produced in unit of time increases with proportionate to cutter (43) number. When a single raw block (6) is cut by using a cutting tool (4) featuring cutters in N number, N+1 unit of insulation paneled slice (7) is formed. If production is conducted in appropriate dimensions, (N+1)³ units of brick (14) can be produced after the following two cutting processes. For instance, when cutting is conducted with three cutters (43), up to 64 bricks (12) can be produced out of a single block (6). Consequently, production duration of each part and the cost are reduced. Moreover, the error ratio in the dimensioning of end products that are formed, as a result of the production of bricks by cutting by means of a cutting tool (4) including multi cutter (43) is reduced. Thus, the energy and time that are spent during the calibration of end products are reduced. The sizes of products, on the other hand, are the same even before the calibration.

According to these general concepts, it is possible to develop various applications of insulated brick production method (100), which is the subject of the invention, and the invention cannot be limited to the examples explained here and it is indeed as stated in the claims.

1-33. (canceled)

34. A method (100) for producing insulated bricks (12) comprising the steps of;
placing insulation panels (2) inside a multi-mold (1) (101),
formation of a raw block (6) by pouring mortar (3) between the insulation panels (2) inside said multi-mold (1) (102),
separation of the raw block (6) from the multi-mold (I) (103),
cutting the raw block (6) (104) using a cutting tool (4) having more than one cutter (43), and
formation (105) of more than one insulation paneled slices (7) at the same cutting time as a result of cutting of said raw block (6).

35. A method (100) for producing insulated bricks (12) as set forth in claim 34 wherein the method further comprises the step of wiping and/or cutting side surfaces (106) of slices (7) for obtaining dimensioned slices (8).

36. A method (100) for producing insulated bricks (12) as set forth in claim 35 wherein the method further comprises the step of transversely cutting the dimensioned slices (8) by using a cutting tool (4) having more than one cutter (43) (107), thereby obtaining transversely dimensioned slices (10).

37. A method (100) for producing insulated bricks (12) as set forth in claim 36 wherein the method further comprises the step of cutting the transversely dimensioned slices (10) lengthwise by using a cutting tool (4) having more than one cutter (43) (109).

38. A method (100) for producing insulated corner bricks (14) comprising the steps of
placing an insulation panel (2) in a framework shaped with a quadrangle cross section in such a way to be parallel to internal walls of a mold (1) that is in rectangular prism shape (201),
adjusting said insulation panel (2) in such a way to leave a distance between each side wall of the mold (1) (202),
formation of a raw block (13) by filling spaces inside and outside said insulation panel (2) within the mold (1) with mortar (203),
separating the raw block (13) from the mold (1) (204),
cutting said raw block (13) into parts by firstly cutting lengthwise (205),
forming a plurality of insulated brick slices (131) by cutting each part transversely (206), and
cutting insulated brick slices (131) using a multi cutting tool (4) having more than one cutters (43).

39. An insulated corner brick (14) obtainable by the method of claim 38.

40. An insulated corner brick (14) as set forth in claim 39 wherein the insulation panel (2) is made of from one or more of Expanded polystyrene foam, compressed chip, wood, chaff, fodder, nutshell, and corncob.

41. An insulated corner brick (14) as set forth in claim 39 wherein the brick has at least one adhesion channel (15) formed on contact surfaces for ensuring solid adhesion.

42. An insulated corner brick (14) as set forth in claim 39 wherein the brick has a joint chamfer (122) that is opened on edges parallel to insulation panel (2).
